(19) United States
(12) Patent Application Publication
(10) Pub. No.: US 2024/0323818 A1
(43) Pub. Date: Sep. 26, 2024

(54) WIRELESS DEVICE, CONTROL METHOD, AND STORAGE MEDIUM

(71) Applicant: BUFFALO INC., Nagoya-shi (JP)

(72) Inventor: Kaoru YANAGIBASHI, Aichi (JP)

(73) Assignee: BUFFALO INC., Nagoya-shi (JP)

(21) Appl. No.: 18/609,723

(22) Filed: Mar. 19, 2024

(30) Foreign Application Priority Data
Mar. 22, 2023 (JP) 2023-045454

(51) Int. Cl. H04W 48/16

(52) U.S. Cl. CPC H04W 48/16

(57) ABSTRACT

A wireless device that includes a wireless communication interface, and processing circuitry configured to control the wireless communication interface to perform simultaneous connection to a wireless terminal using a plurality of bands including at least a first band and a second band different from the first band, and control the wireless communication interface to perform scanning of a wireless channel of the first band in a state in which connection using at least the second band is enabled.

### CROSS-REFERENCE TO RELATED APPLICATION

This application is based on and claims priority under 35 USC 119 from Japanese Patent Application No. 2023-045454 filed on Mar. 22, 2023, the entire content of which is incorporated herein by reference.

### TECHNICAL FIELD

The present disclosure relates to a wireless device, a control method, and a storage medium storing a control program.

### BACKGROUND ART

In a wireless local area network (LAN), wireless communication is performed using frequency bands of 2.4 GHz, 5 GHZ, and 6 GHz. In Wi-Fi 7 (registered trademark), which is one of wireless LAN standards, a Multi-Link Operation (MLO) in which wireless communication is performed using channels of a plurality of frequency bands simultaneously has been studied.

Further, in the wireless LAN, there is a technique of performing an operation called channel scanning when switching a base station with which a wireless terminal performs wireless communication. For example, JP2013-211803A describes a wireless terminal that performs wireless communication with a base station, and performs channel scanning based on a distance to the base station in order to shorten channel scanning time.

### SUMMARY

According to the present disclosure, there is provided a wireless device including: a wireless communication interface; and processing circuitry configured to control the wireless communication interface to perform simultaneous connection to a wireless terminal using a plurality of bands including at least a first band and a second band different from the first band, and control the wireless communication interface to perform scanning of a wireless channel of the first band in a state in which connection using at least the second band is enabled.

According to the present disclosure, there is provided a control method of a wireless device, the control method including: controlling, by processing circuitry of the wireless device, wireless communication interface of the wireless device to perform simultaneous connection to a wireless terminal using a plurality of bands including at least a first band and a second band different from the first band; and controlling, by the processing circuitry of the wireless device, the wireless communication interface of the wireless device to perform scanning of a wireless channel of the first band in a state in which connection using at least the second band is enabled.

According to the present disclosure, there is provided a non-transitory computer readable storage medium storing a control program, the control program causing processing circuitry of a wireless device to execute a process, the process including: controlling a wireless communication interface of the wireless device to perform simultaneous connection to a wireless terminal using a plurality of bands including at least a first band and a second band different from the first band; and controlling the wireless communication interface of the wireless device to perform scanning of a wireless channel of the first band in a state in which connection using at least the second band is enabled.

### BRIEF DESCRIPTION OF DRAWINGS

Exemplary embodiment(s) of the present disclosure will be described in detail based on the following figures, wherein:

FIG. 1 is a diagram showing a configuration of an access point according to an embodiment in the present disclosure;

FIG. 2 is a diagram showing a configuration of a wireless terminal as an example of a wireless terminal;

FIG. 3 is a diagram showing an example of processing performed by a processor of the access point;

FIG. 4 is a diagram showing an example of a change in wireless connection due to scanning of a band;

FIG. 5 is a diagram showing an example of a change in the wireless connection due to scanning of a band;

FIG. 6 is a diagram showing an example of a change in the wireless connection due to sequential scanning of a plurality of bands;

FIG. 7 is a diagram showing an example of communication in a high-speed mode of an MLO;

FIG. 8 is a diagram showing an example of communication in a high-quality mode of the MLO;

FIG. 9 is a diagram showing an example of processing performed by the processor, the processing including determination of a band to be scanned according to a communication scheme; and

FIG. 10 is a diagram showing an example of processing performed by the processor, the processing including switching of the communication scheme before the scanning.

### DESCRIPTION OF EMBODIMENTS

Hereinafter, embodiments of the present disclosure will be described with reference to the drawings.

### <Configuration of Access Point 10>

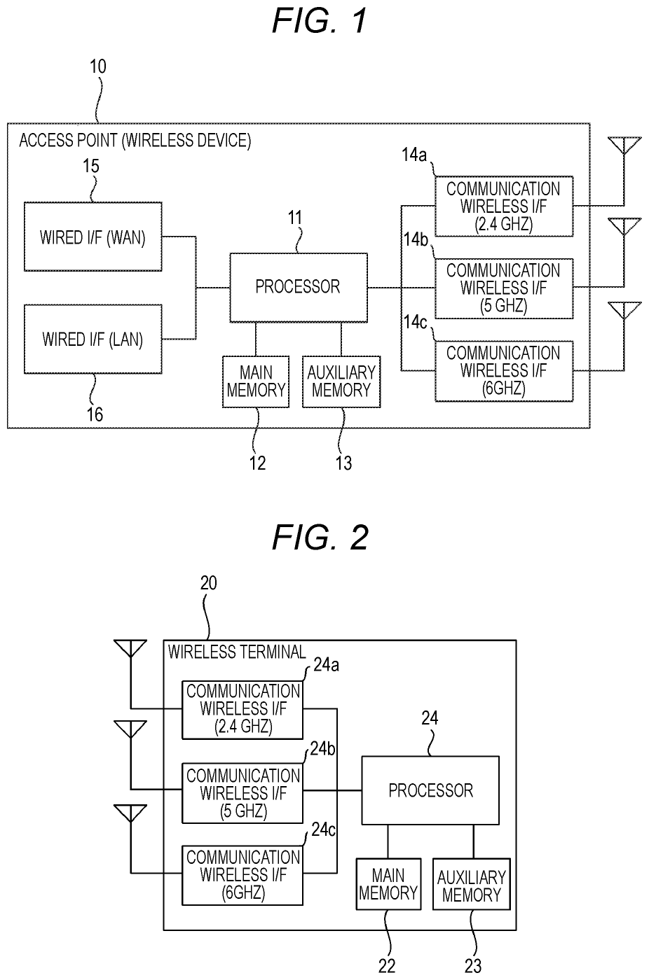

FIG. 1 is a diagram showing a configuration of an access point 10 according to an embodiment in the present disclosure. The access point 10 shown in FIG. 1 is an access point of a wireless LAN such as the Wi-Fi 7 and is an example of a wireless device in the present disclosure.

The access point 10 includes a processor 11, a main memory 12, an auxiliary memory 13, communication wireless I/Fs 14a, 14b, and 14c, and wired I/Fs 15, 16.

The processor 11 is an example of processing circuitry that performs signal processing, and is, for example, a central processing unit (CPU) that controls the entire access point 10. The processor 11 may be implemented by another digital circuit such as a field programmable gate array (FPGA) and a digital signal processor (DSP). The processor 11 may be implemented by combining a plurality of digital circuits.

The main memory 12 is, for example, a random access memory (RAM). The main memory 12 is used as a work area of the processor 11. The auxiliary memory 13 is a nonvolatile memory such as a magnetic disk, an optical disk, or a flash memory. Various programs for operating the access point 10 are stored in the auxiliary memory 13. The programs stored in the auxiliary memory 13 are loaded into the main memory 12 and executed by the processor 11.

The communication wireless I/Fs 14a, 14b, and 14c are communication interfaces that perform wireless communication with a wireless terminal. The communication wireless I/F 14a performs wireless communication using a 2.4 GHz band (frequency band). The communication wireless I/F 14b performs wireless communication using a 5 GHz band. The communication wireless I/F 14c performs wireless communication using a 6 GHz band. The access point 10 may simultaneously connect (for example, an MLO) to the wireless terminal through a plurality of bands using the communication wireless I/Fs 14a, 14b, and 14c. The processor 11 and the communication wireless I/Fs 14a, 14b, and 14c are examples of a wireless unit disclosed in the present disclosure.

The wired I/F 15 is connected to a wide area network (WAN) such as the Internet, and communicates with another communication device via the WAN. The wired I/F 16 is connected to a LAN and communicates with another communication device via the LAN.

For example, the access point 10 relays data communication between the wireless terminal and the communication device on a WAN side by communicating with the wireless terminal through the communication wireless I/Fs 14a, 14b, and 14c and communicating with the communication device on the WAN side through the wired I/F 15. The access point 10 relays data communication between a communication terminal on a LAN side and the communication device on the WAN side by communicating with the communication terminal on the LAN side through the wired I/F 16 and communicating with the communication device on the WAN side through the wired I/F 15.

### <Configuration of Wireless Terminal 20>

FIG. 2 is a diagram showing a configuration of the wireless terminal 20 as an example of the wireless terminal. The wireless terminal 20 shown in FIG. 2 is a wireless terminal supporting wireless communication of a wireless LAN such as the Wi-Fi 7. The wireless terminal 20 includes a processor 21, a main memory 22, an auxiliary memory 23, and communication wireless I/Fs 24a, 24b, and 24c.

The processor 21 is an example of processing circuitry that performs signal processing, and is, for example, a CPU that controls the entire wireless terminal 20. The processor 21 may be implemented by another digital circuit such as an FPGA or a DSP. The processor 21 may further be implemented by combining a plurality of digital circuits.

The main memory 22 is, for example, a RAM. The main memory 22 is used as a work area of the processor 21. The auxiliary memory 23 is a nonvolatile memory such as a magnetic disk, an optical disk, or a flash memory. The auxiliary memory 23 stores various programs for operating the wireless terminal 20. The programs stored in the auxiliary memory 23 are loaded into the main memory 22 and executed by the processor 21.

The communication wireless I/Fs 24a, 24b, and 24c are communication interfaces that perform wireless communication with a wireless terminal. The communication wireless I/F 24a may perform wireless communication using the 2.4 GHz frequency band. The communication wireless I/F 24b may perform wireless communication using the 5 GHZ frequency band. The communication wireless I/F 24c may perform wireless communication using the 6 GHz frequency band.

### <Scanning by Access Point 10>

In a wireless device on a base station side such as an access point, it is conceivable to perform scanning for detecting a channel having better communication quality than a channel in use. However, when the wireless device on the base station side performs the channel scanning, the wireless communication using the channel in use is stopped, and thus the wireless communication of the wireless terminal wirelessly connected to the channel in use may be disconnected.

An object of the present disclosure is to suppress communication disconnection associated with scanning.

### <Processing Performed by Processor 11 of Access Point 10>

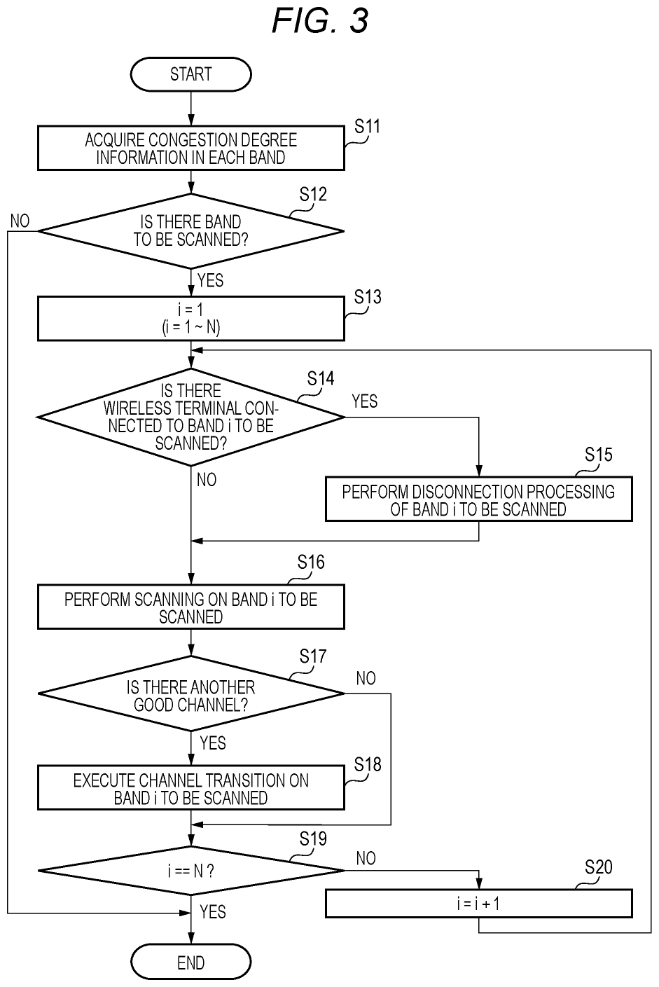

FIG. 3 is a diagram showing an example of processing performed by the processor 11 of the access point 10. The processor 11 repeatedly executes, for example, the processing shown in FIG. 3.

First, the processor 11 acquires congestion degree information indicating a congestion degree of a channel in use in a band used by the access point 10 for wireless communication for each band (for example, 2.4 GHz, 5 GHZ, and 6 GHZ) (step S11).

The congestion degree of the channel is a degree (for example, a time occupancy, a communication amount, or the like) at which the wireless device including the access point 10 uses the channel in a communication area of the access point 10. The higher the congestion degree of the channel, the lower the wireless communication quality of the channel. The congestion degree information is, for example, a value of Transmission Opportunity (TXOP).

Next, based on the congestion degree information acquired in step S11, the processor 11 determines whether there is a band to be scanned among the bands used by the access point 10 for wireless communication (step S12). For example, the processor 11 determines a band whose congestion degree indicated by the congestion degree information exceeds a threshold as a band to be scanned. When there is no band to be scanned (step S12: No), the processor 11 ends a series of processing.

When there is a band to be scanned (step S12: Yes), the processor 11 initializes i to 1 (step S13). The “i” is an index of the band to be scanned, and takes a value of 1 or more and N or less. The “N” is the number of bands to be scanned.

Next, the processor 11 determines whether there is a wireless terminal (for example, the wireless terminal 20) connected to the band i to be scanned, which is the i-th band to be scanned (step S14). When there is no connected wireless terminal (step S14: No), the processor 11 proceeds to step S16.

When there is a wireless terminal connected to the band i to be scanned (step S14: Yes), the processor 11 performs disconnection processing of the band i to be scanned (step S15). For example, the processor 11 transmits, to the wireless terminal connected to the band i to be scanned, a disconnection instruction signal instructing disconnection of the wireless connection through the band i to be scanned.

Next, the processor 11 performs scanning on the band i to be scanned (step S16). The scanning of the band is an operation of receiving a radio wave of each channel of the band. Next, the processor 11 determines whether there is another channel, in the band i to be scanned, having better communication quality than the channel in use (step S17). When there is no other channel having good communication quality (step S17: No), the processor 11 proceeds the processing to step S19. In this case, the access point 10 resumes wireless communication using the channel used before scanning in the band i to be scanned.

When there is the other channel having good communication quality (step S17: Yes), the processor 11 executes channel transition to change the channel used in the band i to be scanned to the other channel (step S18). In this case, the access point 10 starts wireless communication using the channel after the change in the band i to be scanned.

Next, the processor 11 determines whether the value of i is equal to N (step S19). That is, the processor 11 determines whether the scanning has been performed on all the bands to be scanned. When the value of i is not equal to N (step S19: No), the processor 11 increments i (step S20) as it means that there is a band on which scanning has not been performed among the bands to be scanned, and the processing returns to step S14.

When the value of i is equal to N (step S19: Yes), the processor 11 ends the series of processing since the processor 11 has performs scanning on all the bands to be scanned.

In step S15, when disconnecting the connection of the band i to be scanned, the access point 10 may notify the wireless terminal connected to the band i to be scanned that scanning of the band i to be scanned is to be performed. Alternatively, the access point 10 may notify the wireless terminal connected to the band i to be scanned that the band i to be scanned may be connected according to lapse of time after the disconnection of the band i to be scanned. Accordingly, the wireless terminal connected to the band i to be scanned may recognize that a state in which the wireless terminal cannot be connected to the band i to be scanned is temporary, and when a time lapses after the connection of the band i to be scanned is disconnected, it is possible to perform scanning on the band i for connection and smoothly reconnect to the band i after the scanning.

### <Change in Wireless Connection Due to Scanning of Band>

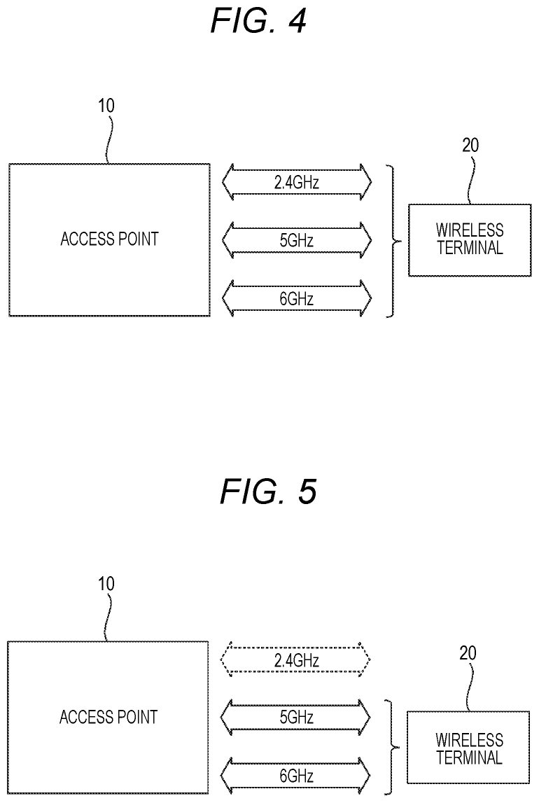

FIGS. 4 and 5 are diagrams showing an example of a change in wireless connection due to scanning of a band. For example, as shown in FIG. 4, it is assumed that the access point 10 and the wireless terminal 20 are wirelessly connected to each other simultaneously at 2.4 GHz, 5 GHZ, and 6 GHz by the MLO and perform wireless communication.

For example, it is assumed that the congestion degree of 2.4 GHz becomes high and the access point 10 performs scanning of 2.4 GHz. In this case, as shown in FIG. 5, the wireless connection between the access point 10 and the wireless terminal 20 at 2.4 GHz is disconnected, and the access point 10 and the wireless terminal 20 are wirelessly connected to each other simultaneously at 5 GHz and 6 GHz and perform wireless communication.

Thereafter, the access point 10 selects a 2.4 GHz channel having good communication quality as a result of scanning of 2.4 GHz, and shifts to a state in which connection is enabled using this channel. Then, the wireless terminal 20 is wirelessly connected to the access point 10 again at 2.4 GHz. Accordingly, the access point 10 and the wireless terminal 20 return to the state of FIG. 4 in which the access point 10 and the wireless terminal 20 are wirelessly connected to each other simultaneously at 2.4 GHZ, 5 GHZ, and 6 GHz and perform the wireless communication.

### <Change in Wireless Connection Due to Sequential Scanning of Plural Bands>

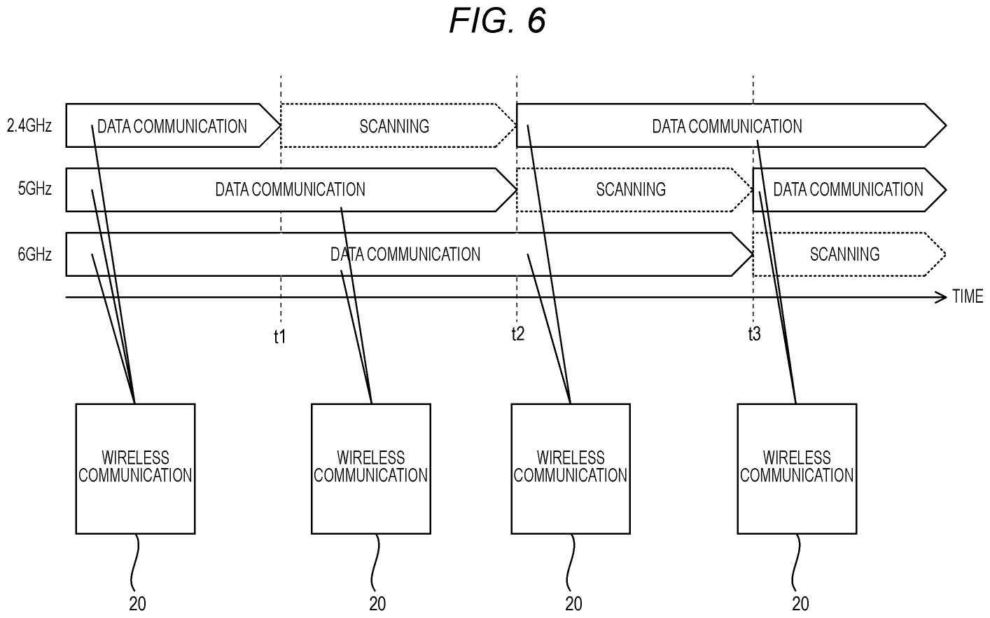

FIG. 6 is a diagram showing an example of a change in wireless connection due to sequential scanning of plural bands. In FIG. 6, a horizontal axis represents time. First, it is assumed that the access point 10 and the wireless terminal 20 are wirelessly connected to each other simultaneously at 2.4 GHz, 5 GHZ, and 6 GHz and perform the wireless communication as in the example of FIG. 4.

In FIG. 6, at time t1, the access point 10 determines all of 2.4 GHZ, 5 GHZ, and 6 GHz as the bands to be scanned based on the congestion degree information of 2.4 GHZ, 5 GHz, and 6 GHz. In this case, for example, the access point 10 first performs disconnection processing of 2.4 GHz and starts scanning of 2.4 GHz. Since the wireless connection at 2.4 GHz is disconnected, the wireless terminal 20 enters a state of being wirelessly connected to the access point 10 at 5 GHz and 6 GHz and the wireless communication with the access point 10 is maintained.

At time t2, the scanning of 2.4 GHz by the access point 10 is completed. As a result of the scanning of 2.4 GHz, the access point 10 selects the 2.4 GHz channel having good communication quality, and resumes the wireless communication using this channel. In addition, the access point 10 performs disconnection processing of 5 GHz and starts scanning of 5 GHz. Since the wireless communication at 2.4 GHz is resumed and the wireless connection at 5 GHz is disconnected, the wireless terminal 20 enters a state of being wirelessly connected to the access point 10 at 2.4 GHz and 6 GHz and the wireless communication with the access point 10 is maintained.

At time t3, the scanning of 5 GHz by the access point 10 is completed. The access point 10 selects a channel of 5 GHz having good communication quality as a result of the scanning of 5 GHZ, and resumes the wireless communication using this channel. The access point 10 performs disconnection processing of 6 GHz and starts scanning of 6 GHz. Since the wireless communication at 5 GHz is resumed and the wireless connection at 6 GHz is disconnected, the wireless terminal 20 enters a state of being wirelessly connected to the access point 10 at 2.4 GHz and 5 GHz and the wireless communication with the access point 10 is maintained.

As described above, when there are a plurality of bands to be scanned among the bands usable by the access point 10, the access point 10 sequentially performs scanning on the bands to be scanned. The sequential execution is not simultaneous execution but execution one by one. Accordingly, the possibility that the wireless terminal is wirelessly connected to the access point 10 using a band other than the band to be scanned increases as compared with a configuration in which scanning of the plural bands to be scanned is simultaneously performed, and communication disconnection caused by the scanning executed by the access point 10 may be suppressed.

As described above, the access point 10 may simultaneously be connected to the wireless terminal (for example, the wireless terminal 20) through the plural bands, and performs scanning of a wireless channel of another second band (band to be scanned) in a state in which connection is enabled through at least one first band. For example, in the examples shown in FIGS. 4 and 5, the access point 10 performs scanning of 2.4 GHz in a state in which connection is enabled at 5 GHz and 6 GHZ.

Accordingly, for example, even when a wireless terminal is connected through the second band (for example, 2.4 GHZ) to be scanned, if the wireless terminal is also connected through the first band (for example, 5 GHZ and 6 GHZ), it is possible to suppress communication disconnection between the access point 10 and the wireless terminal 20 due to scanning in the second band. Therefore, it is possible to suppress communication disconnection due to scanning executed by the access point 10.

Further, the access point 10 performs scanning on a band whose congestion degree satisfies a predetermined condition (for example, a band whose congestion degree exceeds the threshold) among bands usable by the access point 10. Accordingly, when there is a band in which the channel currently used is congested, the communication quality of each channel of the band is measured, and the channel may be shifted to a channel having good communication quality. Accordingly, it is possible to improve communication quality by performing channel switching in the band while suppressing communication disconnection.

The access point 10 disconnects the connection of the second band (band to be scanned) and then performs scanning on the second band. Accordingly, it is possible to suppress an erroneous operation of the wireless terminal due to the execution of the scanning of the second band.

When disconnecting the connection of the second band (band to be scanned), the access point 10 may notify the wireless terminal connected to the second band that the second band is scanned or that the connection of the second band is possible according to a time lapse after the disconnection of the connection of the second band. Accordingly, the wireless terminal connected to the second band may recognize that the state in which the wireless terminal cannot be connected to the second band is temporary, and after the disconnection of the second band, it is possible to scan the second band for connection repeatedly or after a time period and smoothly reconnect to the channel of the second band after the scan.

Further, in a case where there are plural bands whose congestion degrees satisfy the predetermined condition (for example, bands whose congestion degrees exceed the threshold) among the bands usable by the access point 10, the access point 10 sequentially executes scanning of the bands. Accordingly, the possibility that the wireless terminal is wirelessly connected to the access point 10 using bands other than the band to be scanned increases as compared with the configuration in which scanning of the plural bands is simultaneously performed, and communication disconnection caused by the scanning executed by the access point 10 may be suppressed.

### <Communication in High-Speed Mode of MLO>

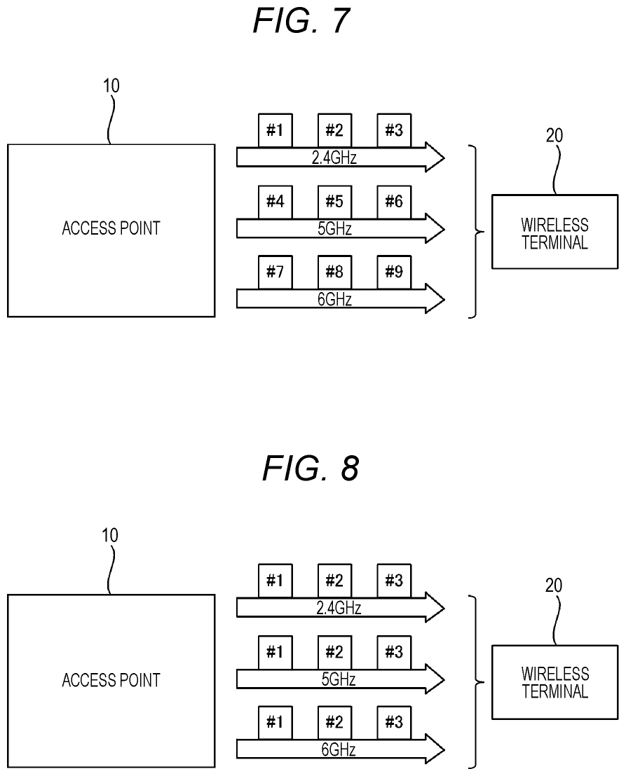

FIG. 7 is a diagram showing an example of communication in a high-speed mode of the MLO. The access point 10 and the wireless terminal 20 may communicate with each other in the high-speed mode of the MLO, for example. Here, a case where data #1, #2, #3, . . . are transmitted from the access point 10 to the wireless terminal 20 will be described.

In the high-speed mode, the access point 10 distributes the data #1, #2, #3, . . . to three bands of, for example, 2.4 GHz, 5 GHZ, and 6 GHz and transmits the data #1, #2, #3, to the wireless terminal 20. Specifically, the access point 10 transmits the data #1 to #3 at 2.4 GHz, the data #4 to #6 at 5 GHz, and data #7 to #9 at 6 GHz. Further, although not shown in the drawings, the access point 10 transmits the data #10 to #12 at 2.4 GHZ, the data #13 to #15 at 5 GHz, and the data #16 to #18 at 6 GHz. Accordingly, it is possible to transmit the data #1, #2, #3, . . . from the access point 10 to the wireless terminal 20 at a higher speed (for example, about three times) than in a case where one band is used.

### <Communication in High-Quality Mode of MLO>

FIG. 8 is a diagram showing an example of communication in a high-quality mode of the MLO. The access point 10 and the wireless terminal 20 may communicate with each other in the high-quality mode of the MLO, for example. Here, a case where data #1, #2, #3, . . . are transmitted from the access point 10 to the wireless terminal 20 will be described.

In the high-quality mode, the access point 10 transmits the data #1, #2, #3, . . . to the wireless terminal 20 through three bands of, for example, 2.4 GHZ, 5 GHz, and 6 GHz. Accordingly, it is possible to transmit the data #1, #2, #3, . . . from the access point 10 to the wireless terminal 20 with redundancy compared to the case where one band is used.

### <Determination of Band to be Scanned According to Communication Scheme>

As shown in FIGS. 7 and 8, the access point 10 may be able to communicate with a wireless terminal (for example, the wireless terminal 20) by switching plural communication schemes such as the high-speed mode and the high-quality mode. In this case, the access point 10 may determine the band to be scanned according to the communication scheme being executed using the MLO with the connected wireless terminal.

For example, in the wireless communication in the high-speed mode, when a part of bands in use are disconnected, data loss occurs, and processing such as retransmission is required, and thus it is considered that an influence of scanning on communication is larger than in wireless communication in the high-quality mode. Therefore, for example, the access point 10 may make a determination such that a band to which the wireless terminal that is performing communication in the high-speed mode is connected is less likely to be scanned.

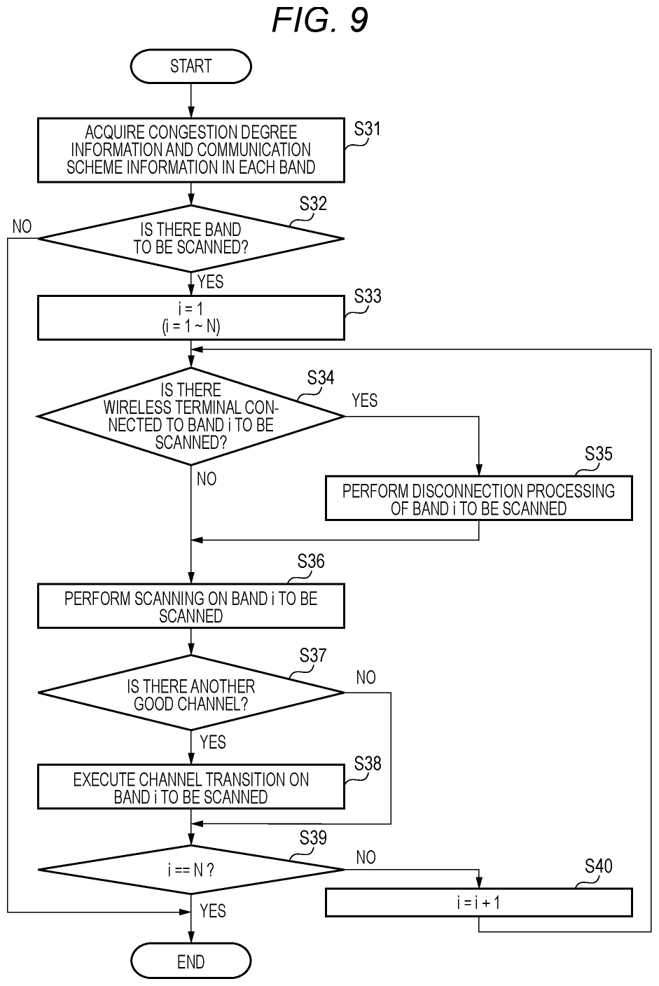

FIG. 9 is a diagram showing an example of processing performed by the processor 11 including determination of a band to be scanned according to a communication scheme. The processor 11 may repeatedly execute the processing shown in FIG. 9, for example. Steps S31 to S40 shown in FIG. 9 are substantially the same as steps S11 to S20 shown in FIG. 3.

However, in step S31 shown in FIG. 9, the processor 11 acquires, in addition to the congestion degree information for each band, communication scheme information indicating a communication scheme that is running in the communication with the wireless terminal connected to each band using the MLO. For example, the communication scheme information is acquired for each of the wireless terminals connected to the access point 10 through each band.

In step S32, the processor 11 determines the band to be scanned based on the congestion degree information and the communication scheme information acquired in step S31. For example, the processor 11 sets a higher threshold compared with the congestion degree indicated by the congestion degree information for a band to which the wireless terminal that is performing communication in the high-speed mode is connected than for a band to which the wireless terminal performing communication in the high-speed mode is not connected. Accordingly, the band to which the wireless terminal that is performing communication in the high-speed mode is connected is less likely to be scanned.

The processor 11 may set a higher threshold that is compared with the congestion degree indicated by the congestion degree information according to the number of wireless terminals that are performing communication in the high-speed mode, the priority of communication performed by the wireless terminals performing communication in the high-speed mode, or the like.

In this way, by setting the predetermined condition to be satisfied by the congestion degree for determining the band to be scanned to a condition according to the communication scheme being executed using the MLO, it is possible to perform scanning in consideration of the influence of scanning on communication.

### <Switching of Communication Scheme Before Scanning>

The access point 10 may perform scanning of the band to be scanned after switching the communication scheme in which the access point 10 is connected with the wireless terminal through the band to be scanned to a predetermined communication scheme.

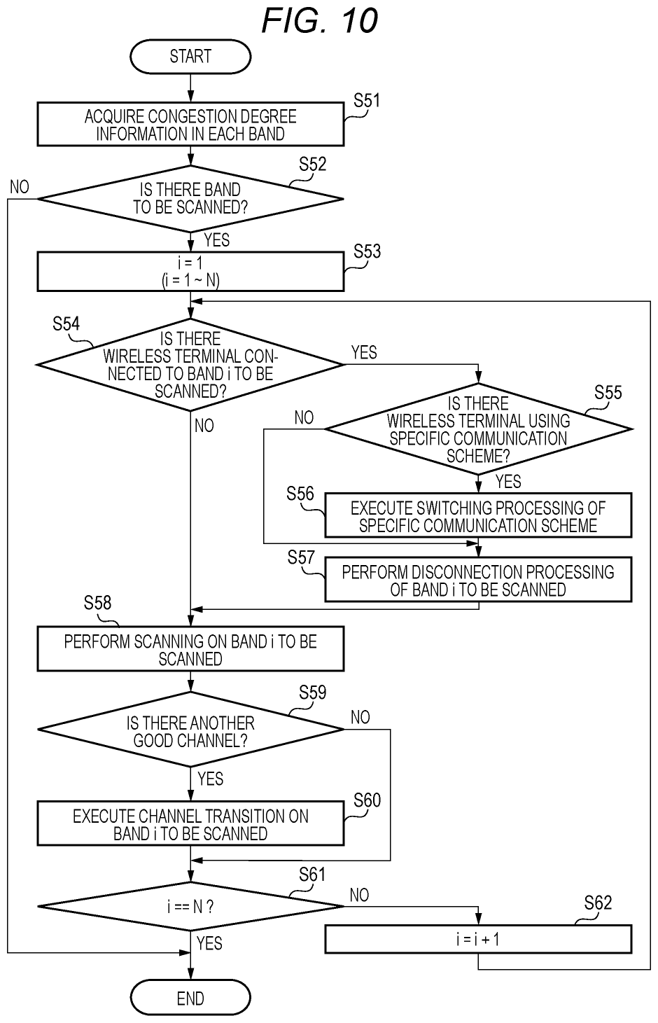

FIG. 10 is a diagram showing an example of processing performed by the processor 11, the processing including switching of the communication scheme before the scanning. The processor 11 may repeatedly execute the processing shown in FIG. 10, for example. Steps S51 to S60 shown in FIG. 10 are substantially the same as steps S11 to S20 shown in FIG. 3.

However, in this example, when there is a wireless terminal connected to the band i to be scanned (step S54: Yes), the processor 11 determines whether there is a wireless terminal that is performing communication in a specific communication scheme among the wireless terminals connected to the band i to be scanned (step S61). The specific communication scheme is, for example, a communication scheme (for example, the high-speed mode) in which an influence of disconnection is relatively large.

When there is no wireless terminal that is performing communication in the specific communication scheme (step S61: No), the processor 11 proceeds to step S55. When there is a wireless terminal that is performing communication in the specific communication scheme (step S61: Yes), the processor 11 executes switching processing of switching the communication scheme of the wireless terminal that is performing communication in the specific communication scheme through the band i to be scanned to the predetermined communication scheme (step S62), and proceeds to step S55. The predetermined communication scheme is, for example, a communication scheme (for example, the high-quality mode) in which the influence of disconnection is relatively small. The switching processing is performed by the access point 10, for example, by transmitting a switching instruction signal instructing switching of the communication scheme to the wireless terminal.

In this way, by performing the scanning of the second band after switching the communication scheme in which with the wireless terminal is connected through the second band (the band to be scanned) to the predetermined communication scheme, it is possible to perform the scanning under a state in which the influence of the scanning on the communication may be suppressed.

Although the case where the specific communication scheme (the communication scheme in which the influence of disconnection is relatively large) and the predetermined communication scheme (the communication scheme in which the influence of disconnection is relatively small) are the high-speed mode and the high-quality mode, respectively, has been described, the specific communication scheme and the predetermined communication scheme are not limited thereto. For example, the specific communication scheme may be non-MLO (communication through one band), and the predetermined communication scheme may be MLO. Further, the specific communication scheme may be a scheme in which communication is performed by distributing uplink transmission and downlink transmission to different bands in the MLO, and the predetermined communication scheme may be a scheme in which communication is performed in both directions in each band in the MLO.

When the wireless terminal that switched the communication scheme to the predetermined method by the switching processing in step S62 shown in FIG. 10 is connected to the access point 10 again after scanning, the access point 10 may perform return processing of the communication scheme of the wireless terminal to the specific communication scheme used before switching, from the predetermined communication scheme. The return processing is performed, for example, when the access point 10 transmits the switching instruction signal for instructing switching of the communication scheme to the wireless terminal.

### (Modification)

Although a configuration in which the access point 10 includes the wired I/F 16 has been described, the access point 10 may not include the wired I/F 16.

Although the configuration in which the access point 10 and the wireless terminal 20 perform wireless communication according to the Wi-Fi 7 has been described, a communication standard used for the wireless communication by the access point 10 and the wireless terminal 20 is not limited to the Wi-Fi 7, and may be, for example, a successor standard of the Wi-Fi 7.

Although TXOP has been described as an example of the band congestion degree information, the band congestion degree information is not limited to TXOP. For example, the band congestion degree information may be information indicating communication quality such as noise intensity, an error rate, and a retransmission rate in the wireless communication performed by the access point 10 through the band.

The above-described embodiments may be implemented in combination.

### (Control Program)

The control method described in the above embodiment may be implemented by executing a control program prepared in advance on a computer. The control program is stored in a computer-readable storage medium and is executed by being read from the storage medium. The control program may be provided by being stored in a non-transitory storage medium such as a flash memory, or may be provided via a network such as the Internet. The computer that executes the control program may be included in a wireless device, may be included in an electronic device such as a smartphone, a tablet terminal, or a personal computer that can communicate with the wireless device, or may be included in a server device that can communicate with a control device and the electronic device.

As described above, the following matters are disclosed in this specification.

A wireless device disclosed herein includes: a wireless communication interface; and processing circuitry configured to control the wireless communication interface to perform simultaneous connection to a wireless terminal using a plurality of bands including at least a first band and a second band different from the first band, and control the wireless communication interface to perform scanning of a wireless channel of the first band in a state in which connection using at least the second band is enabled.

The processing circuitry may be configured to control the wireless communication interface to perform the scanning of the wireless channel of the first band whose congestion degree satisfies a predetermined condition among the plurality of bands.

The processing circuitry may be configured to control the wireless communication interface to perform the scanning of the wireless channel of the first band after connection using the first band is disconnected.

In a case where there are two or more bands whose congestion degrees satisfy the predetermined condition, the processing circuitry may control the wireless communication interface to sequentially perform scanning of wireless channels of the the two or more bands whose congestion degrees satisfy the predetermined condition.

The congestion degree may be information based on Transmission Opportunity.

The predetermined condition may be a condition corresponding to a communication scheme being executed in the simultaneous connection through the plurality of bands.

The processing circuitry may be configured to control the wireless communication interface to notify, before the connection using the first band is disconnected, the wireless terminal connected to the wireless device through the first band that the scanning of the wireless channel of the first band is to be performed.

The processing circuitry may be configured to control the wireless communication interface to notify, before the connection using the first band is disconnected, the wireless terminal connected to the wireless device through the first band that the connection of the first band is enabled after time elapses after the connection using the first band is disconnected.

The processing circuitry may be configured to control the wireless communication interface to perform the scanning of the wireless channel of the first band after switching a communication scheme executed between the wireless device and the wireless terminal connected to the wireless device through the first band to a predetermined communication scheme.

The wireless device may be an access point configured to relay data communication between the wireless terminal and a network.

A control method of a wireless device disclosed herein includes: controlling, by processing circuitry of the wireless device, wireless communication interface of the wireless device to perform simultaneous connection to a wireless terminal using a plurality of bands including at least a first band and a second band different from the first band; and controlling, by the processing circuitry of the wireless device, the wireless communication interface of the wireless device to perform scanning of a wireless channel of the first band in a state in which connection using at least the second band is enabled.

In a non-transitory computer readable storage medium storing a control program disclosed herein, the control program causing processing circuitry of a wireless device to execute a process, the process includes: controlling a wireless communication interface of the wireless device to perform simultaneous connection to a wireless terminal using a plurality of bands including at least a first band and a second band different from the first band; and controlling the wireless communication interface of the wireless device to perform scanning of a wireless channel of the first band in a state in which connection using at least the second band is enabled.

What is claimed is:

1. A wireless device comprising:
a wireless communication interface; and
processing circuitry configured to
control the wireless communication interface to perform simultaneous connection to a wireless terminal using a plurality of bands including at least a first band and a second band different from the first band, and
control the wireless communication interface to perform scanning of a wireless channel of the first band in a state in which connection using at least the second band is enabled.

2. The wireless device according to claim 1, wherein
the processing circuitry is configured to control the wireless communication interface to perform the scanning of the wireless channel of the first band whose congestion degree satisfies a predetermined condition among the plurality of bands.

3. The wireless device according to claim 2, wherein
the processing circuitry is configured to control the wireless communication interface to perform the scanning of the wireless channel of the first band after connection using the first band is disconnected.

4. The wireless device according to claim 3, wherein,
in a case where there are two or more bands whose congestion degrees satisfy the predetermined condition, the processing circuitry controls the wireless communication interface to sequentially perform scanning of wireless channels of the the two or more bands whose congestion degrees satisfy the predetermined condition.

5. The wireless device according to claim 3, wherein
the congestion degree is information based on Transmission Opportunity.

6. The wireless device according to claim 3, wherein
the predetermined condition is a condition corresponding to a communication scheme being executed in the simultaneous connection through the plurality of bands.

7. The wireless device according to claim 3, wherein
the processing circuitry is configured to control the wireless communication interface to notify, before the connection using the first band is disconnected, the wireless terminal connected to the wireless device through the first band that the scanning of the wireless channel of the first band is to be performed.

8. The wireless device according to claim 3, wherein
the processing circuitry is configured to control the wireless communication interface to notify, before the connection using the first band is disconnected, the wireless terminal connected to the wireless device through the first band that the connection of the first band is enabled after time elapses after the connection using the first band is disconnected.

9. The wireless device according to claim 3, wherein
the processing circuitry is configured to control the wireless communication interface to perform the scanning of the wireless channel of the first band after switching a communication scheme executed between the wireless device and the wireless terminal connected to the wireless device through the first band to a predetermined communication scheme.

10. The wireless device according to claim 3, wherein
the wireless device is an access point configured to relay data communication between the wireless terminal and a network.

11. A control method of a wireless device, the control method comprising:
controlling, by processing circuitry of the wireless device, wireless communication interface of the wireless device to perform simultaneous connection to a wireless terminal using a plurality of bands including at least a first band and a second band different from the first band; and
controlling, by the processing circuitry of the wireless device, the wireless communication interface of the wireless device to perform scanning of a wireless channel of the first band in a state in which connection using at least the second band is enabled.

12. A non-transitory computer readable storage medium storing a control program, the control program causing processing circuitry of a wireless device to execute a process, the process comprising:
controlling a wireless communication interface of the wireless device to perform simultaneous connection to a wireless terminal using a plurality of bands including at least a first band and a second band different from the first band; and
controlling the wireless communication interface of the wireless device to perform scanning of a wireless channel of the first band in a state in which connection using at least the second band is enabled.
